(19) United States
(12) Patent Application Publication
(10) Pub. No.: US 2025/0359677 A1
(43) Pub. Date: Nov. 27, 2025

(54) Deformation-Resistant Load-Bearing Rod for Seat

(71) Applicant: ZIYUE ELECTRONIC COMMERCE LIMITED, Hong Kong (CN)

(72) Inventor: Fan YANG, Hong Kong (CN)

(73) Assignee: ZIYUE ELECTRONIC COMMERCE LIMITED, Hong Kong (CN)

(21) Appl. No.: 19/087,527

(22) Filed: Mar. 23, 2025

(30) Foreign Application Priority Data
May 27, 2024 (CN) 202421171453.6

(51) Int. Cl. A47C 5/04; F16B 12/40

(52) U.S. Cl. CPC A47C 5/043; F16B 12/40

(57) ABSTRACT

The present disclosure relates to a deformation-resistant load-bearing rod for a seat, aiming to solve the problems of plastic deformation and structural failure after long-term use in existing technologies. The load-bearing rod for a seat comprises a rod and a load-bearing part. The rod adopts a hollow cylindrical structure to optimize the moment of inertia of the cross-section, and both ends are connected to the seat through mounting holes in a three-point fastening manner. The inner wall has anti-slip threads to ensure stability under dynamic loads. The load-bearing part is designed as a racetrack-shaped curved column, with its radially extending load-bearing wall forming a sleeve structure with the rod. The load-bearing part can rotate axially around the rod to dynamically adjust the stress angle, thereby extending the fatigue life of the material.

### CROSS-REFERENCE TO RELATED APPLICATIONS

This application claims priority to Chinese Patent Application No. 202421171453.6, filed on May 27, 2024, entitled “Deformation-Resistant Load-Bearing Rod for Seat”, the entire contents of which, including any amendments, are incorporated herein by reference.

### TECHNICAL FIELD

The present disclosure relates to the field of seat technology, particularly to a deformation-resistant load-bearing rod for a seat.

### BACKGROUND

Existing load-bearing rods for seat mostly adopt a single-layer tubular structure (such as U.S. Patent Applications with publication numbers US20190045931A1, U.S. Pat. No. 4,775,182A, and US20070063550A1), which has weak deformation resistance and is prone to bending deformation due to human body weight or external forces. For example, when traditional load-bearing rods directly bear concentrated loads, they lack an effective stress dispersion mechanism, leading to local stress concentration, which can result in plastic deformation or even fracture after long-term use. Additionally, some designs disperse pressure through load-bearing canvas, but the structure of the load-bearing rod itself remains unimproved, still posing a risk of deformation.

The existing load-bearing rods for seat have insufficient deformation resistance. Traditional single-layer tubular load-bearing rods are prone to bending deformation at stress points, making it difficult to maintain structural stability over the long term. One of the reasons for this is uneven stress distribution, where concentrated loads lead to excessively high local stress, accelerating material fatigue and limiting the applicable scenarios of load-bearing rod for seats. The current structures are difficult to meet the high-strength support requirements (such as for industrial equipment seats, heavy furniture, etc.). Therefore, there is an urgent need for a new load-bearing rod structure to enhance deformation resistance and service life.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various embodiments of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

The present disclosure provides a deformation-resistant load-bearing rod for a seat to solve the problems mentioned in the background art.

To achieve the above-mentioned object, the present disclosure adopts the following technical solution:

A load-bearing rod for a seat includes:
a rod, extending axially, with both ends respectively provided with a first connecting end and a second connecting end for assembly and connection with the seat; and
a load-bearing part, located between the first connecting end and the second connecting end of the rod, the load-bearing part comprising a load-bearing wall extending radially outward from the rod, the load-bearing wall having an attaching end and a distal end opposite to each other, the attaching end being configured for connection with the rod, and the distal end extending from the rod constituting a stress surface for bearing external loads.

### BRIEF DESCRIPTION OF DRAWINGS

The drawings, which form a part of this application, are provided to further explain the present disclosure. The schematic embodiments and the descriptions thereof are used to illustrate the disclosure and do not constitute an improper limitation of the disclosure. In the drawings:

FIG. 1 is a perspective schematic diagram of an embodiment provided by the present disclosure;

FIG. 2 is a perspective schematic diagram of a rod in the embodiment of FIG. 1;

FIG. 3 is a cross-sectional view of the rod in the embodiment shown in FIG. 2;

FIG. 4 is a perspective schematic diagram of the load-bearing part in the embodiment shown in FIG. 1;

FIG. 5 is a cross-sectional view of the embodiment shown in FIG. 1;

FIG. 6 is a perspective schematic diagram of another embodiment provided by the present disclosure;

FIG. 7 is a cross-sectional view of the embodiment shown in FIG. 6;

FIG. 8 is a schematic diagram of the connection between the load-bearing rod for a seat and the seat in the embodiment shown in FIG. 1;

FIG. 9 is a schematic diagram of another embodiment of the structure shown in FIG. 5.

FIG. 10 is a force analysis diagram of the embodiment in FIG. 1 (only showing the maximum external force F1);

FIG. 11 is a force analysis diagram of the embodiment in FIG. 5 (only showing the main external forces).

Reference signs: Load-bearing rod for a seat (10); Seat (20); Through hole (21); Mating hole (22); Seat frame (23); Rod (100); First end (101); Second end (102); Outer surface (103); Mounting hole (110); Threaded fastener (120); Load-bearing part (200); Load-bearing wall (210); Attaching end (211); Distal end (212); Inner wall surface (220); Accommodating chamber (221); Secondary connecting end (230); Connecting hole (231).

### DESCRIPTION OF EMBODIMENTS

In describing the preferred embodiments, specific termi-nology will be resorted to for the sake of clarity. It is to be understood that each specific term includes all technical equivalents which operate in a similar manner to accomplish a similar purpose.

While various aspects and features of certain embodiments have been summarized above, the following detailed description illustrates a few exemplary embodiments in further detail to enable one skilled in the art to practice such embodiments. Reference will now be made in detail to embodiments of the inventive concept, examples of which are illustrated in the accompanying drawings. The accompanying drawings are not necessarily drawn to scale. The described examples are provided for illustrative purposes and are not intended to limit the scope of the invention. It should be understood, however, that persons having ordinary skill in the art may practice the inventive concept without these specific details.

It will be understood that, although the terms first, second, etc. may be used herein to describe various elements, these elements should not be limited by these terms. These terms are only used to distinguish one element from another. For example, a first attachment could be termed a second attachment, and, similarly, a second attachment could be termed a first attachment, without departing from the scope of the inventive concept.

It will be understood that when an element or layer is referred to as being “on,” “coupled to,” or “connected to” another element or layer, it can be directly on, directly coupled to or directly connected to the other element or layer, or intervening elements or layers may be present. In contrast, when an element is referred to as being “directly on,” “directly coupled to,” or “directly connected to” another element or layer, there are no intervening elements or layers present. Like numbers refer to like elements throughout. As used herein, the term “and/or” includes any and all combinations of one or more of the associated listed items.

As used in the description of the inventive concept and the appended claims, the singular forms “a,” “an,” and “the” are intended to include the plural forms as well, unless the context clearly indicates other.

In the present disclosure, to address the technical issues in the prior art where load-bearing rod for a seat has insufficient bending stiffness, is prone to plastic bending deformation under concentrated point loads, and is susceptible to structural failure after long-term use, a deformation-resistant load-bearing rod for a seat is provided. This load-bearing rod for a seat, through the synergistic combination of composite cross-section design and a rotatable pressure-bearing structure, not only significantly enhances the ultimate load-bearing capacity but also dynamically adjusts the stress distribution area through axial rotation, thereby effectively delaying material fatigue. The preferred embodiments of the present disclosure will be described in detail below with reference to the accompanying drawings.

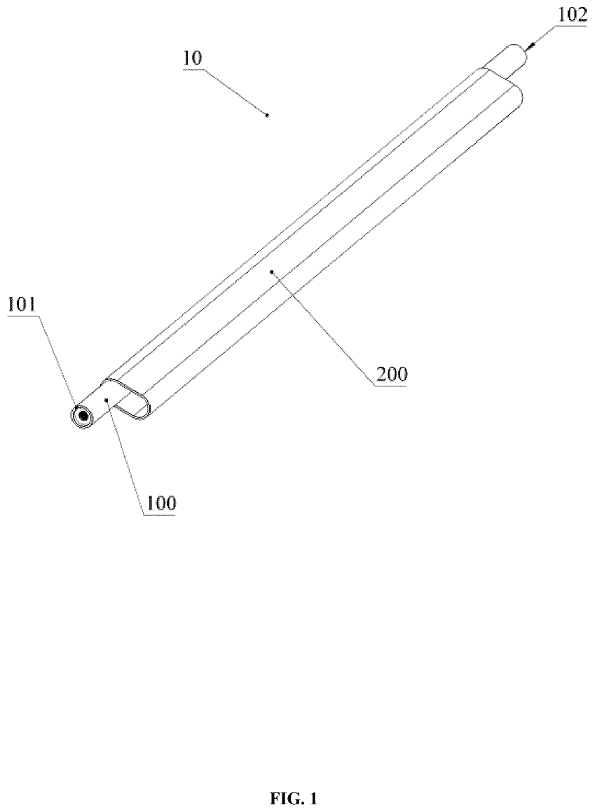

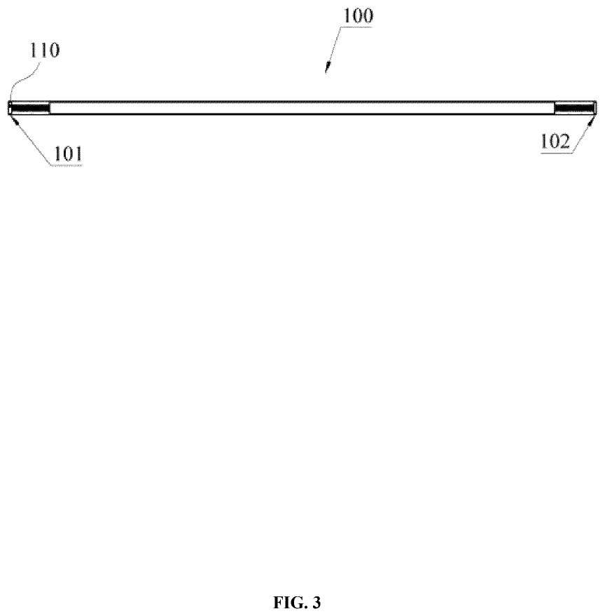

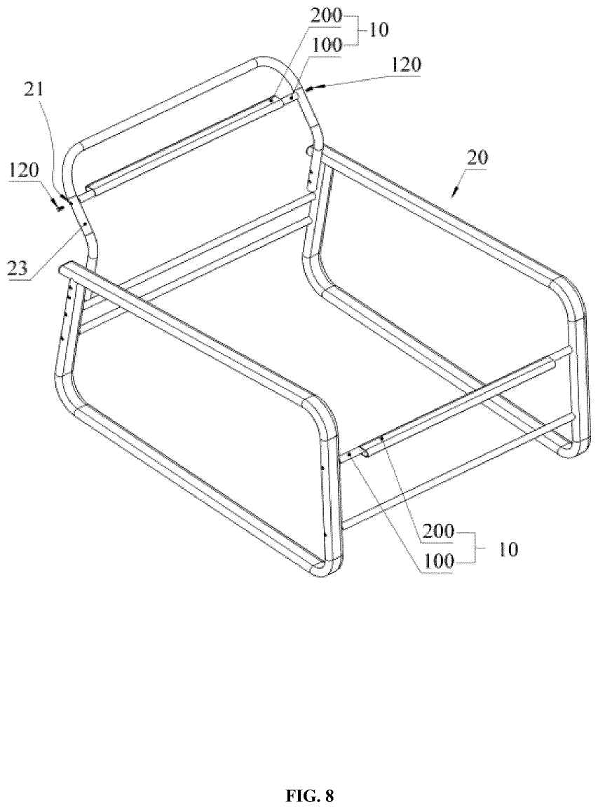

As shown in FIGS. 1 to 8, the load-bearing rod 10 for a seat of this embodiment includes a rod 100 and a load-bearing part 200. The rod 100 adopts a cylindrical structure with a hollow interior and open ends. Its tubular construction significantly enhances bending stiffness through optimized moment of inertia. The rod 100 has an axial length adapted to ergonomics to meet the support needs of seats for users of different body types. As shown in FIG. 8, in terms of structural configuration, the rod 100 has two connecting ends, a first end 101 and a second end 102. The load-bearing rod 10 for a seat is assembled and connected to the seat 20 through the first end 101 and the second end 102 of the rod 100.

In other embodiments, the cross-section of the rod 100 can also be set to shapes other than circular, including but not limited to square, polygonal, elliptical, and any other desired shapes.

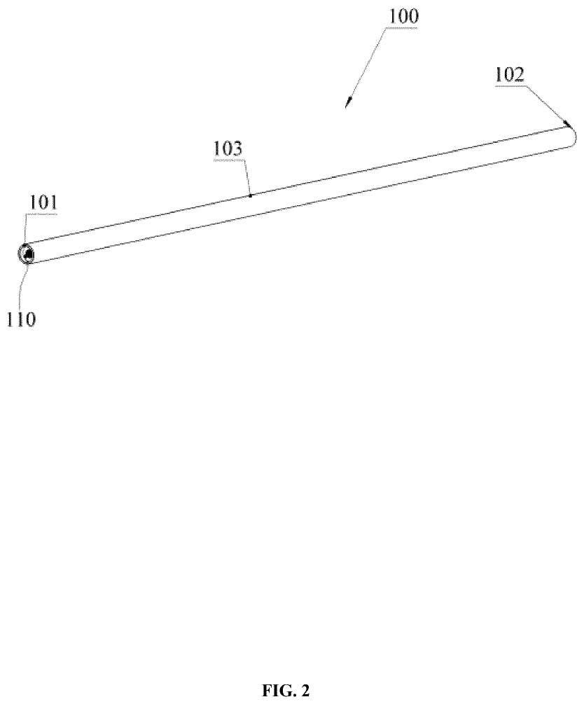

Specifically, referring to FIGS. 2, 3, and 8, in this embodiment, both the first end 101 and the second end 102 of the rod 100 are provided with fixed mounting holes 110. The seat 20 is provided with through holes 21 at positions corresponding to the mounting holes 110. A threaded fastener 120 is coaxially passed through the through hole 21 and the mounting hole 110 in sequence, achieving a three-point reliable connection between the load-bearing rod 10 for a seat and the seat 20. Notably, the inner wall of the mounting hole 110 is provided with an anti-slip thread structure, which can effectively prevent the fastener from loosening under dynamic loads.

In other embodiments (not shown), the fixed connection between the load-bearing rod 10 for a seat and the seat 20 is not limited to bolt structures. It can also be achieved through pin connections, rivet connections, and any other connection methods for fixed or rotational connections. Similarly, a snap-fit connection structure can be used, where snap protrusions are set at the first end 101 and the second end 102 of the rod 100, and corresponding mounting slots are set at the corresponding positions of the seat 20, forming a detachable connection between the load-bearing rod 10 for a seat and the seat 20 through the snap-fit structure.

Referring to FIG. 1, in this embodiment, the load-bearing part 200 is set between the first end 101 and the second end 102 of the rod 100. The load-bearing part 200 is configured as an arc-shaped column with a ring-shaped racetrack cross-section, which approximates an elliptical shape, mainly composed of two semicircles connected by two equal-length parallel line segments. This shape is also suitable for capsule-shaped cross-sections and stadium outer rings. The ring-shaped racetrack cross-section design of the load-bearing part 200 can significantly enhance bending stiffness by increasing the moment of inertia. The top arc contour and the bottom plane work together to form a continuous stress transfer path and a stable support interface.

In other embodiments, the cross-section of the load-bearing part 200 can also be set to circular, square, polygonal, and any other desired shapes.

In the preferred embodiment, the rod 100 and the load-bearing part 200 can be made of metal materials. However, it should be appreciated that the material system does not limit the technical solution. According to the requirements of actual application scenarios, the manufacturing materials of the rod and the load-bearing part can include, but are not limited to, engineering plastics, silicon-based composite materials, hardwood materials, or their combinations. The metal material solution is particularly suitable for situations that need to bear large loads, while lightweight scenarios can use non-metallic materials such as carbon fiber reinforced polymers.

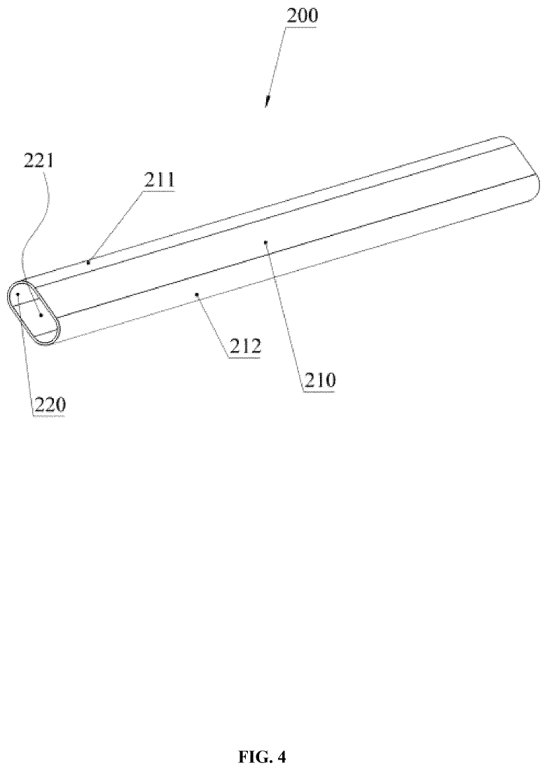

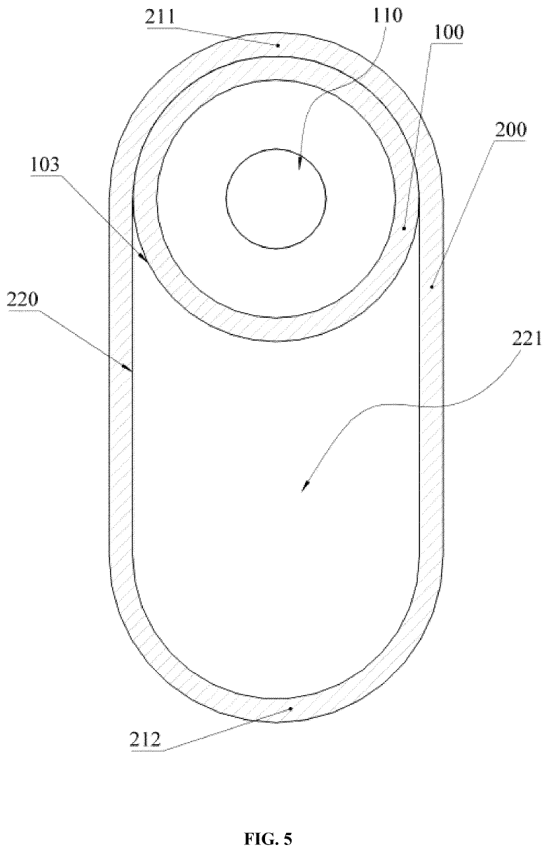

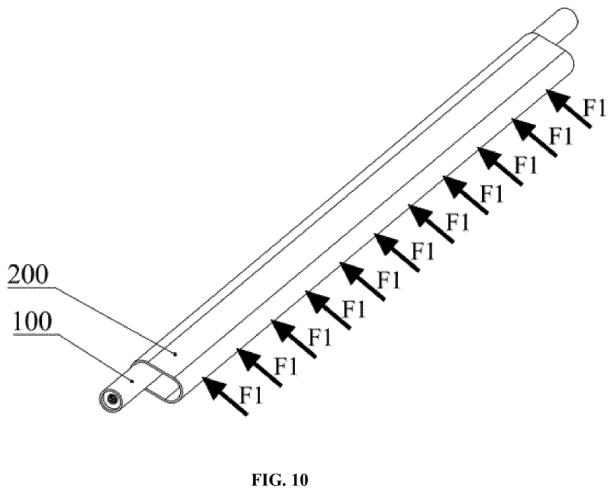

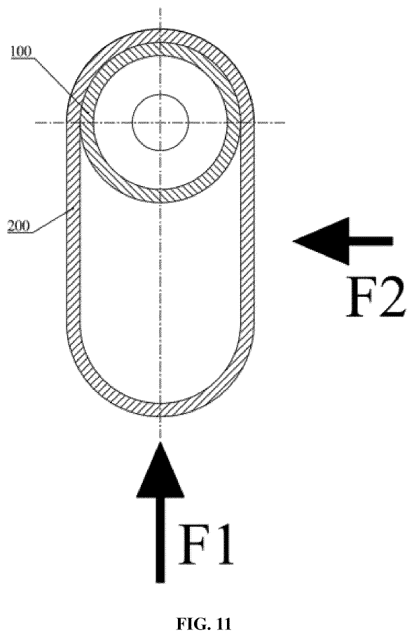

Specifically, referring to FIGS. 4 and 5, the load-bearing part 200 extends radially outward from the rod 10 to form a load-bearing wall 210. The load-bearing wall 210 includes an attaching end 211 and a distal end 212. The attaching end 211 of the load-bearing wall 210 engages with the outer surface 103 of the rod 100, forming a sleeve-like structure between the load-bearing part 200 and the rod 100. The distal end 212 of the load-bearing wall 210 constitutes a force-bearing surface for external loads. As shown in FIGS. 10 and 11, when a user applies force to the seat 20 (see FIG. 8), under vertical load, the deformation of the load-bearing fabric generates a load decomposed into a main component F1 along the rod axis and a transverse component F2. At a certain height from the support end, a dangerous section forms a composite stress state dominated by bending stress and supplemented by shear stress.

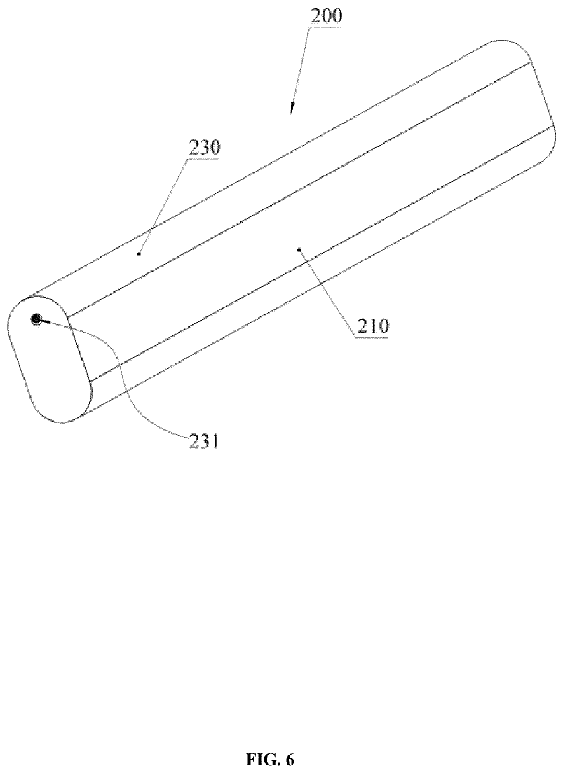

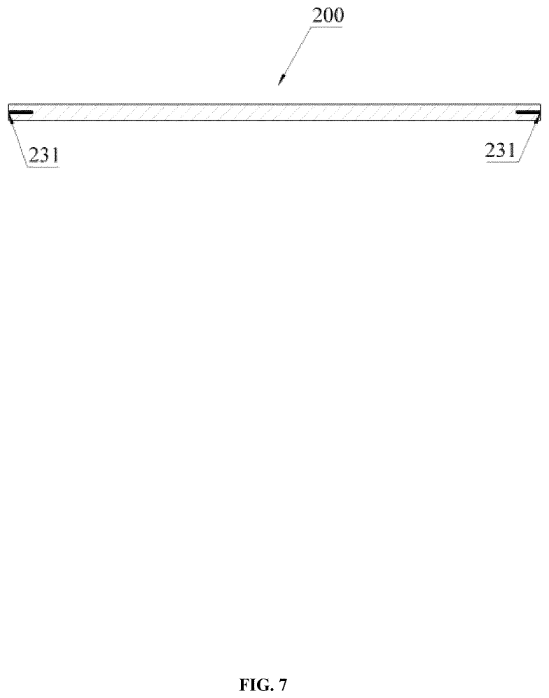

In other embodiments (see FIGS. 6 and 7), the rod 100 can be omitted, and the load-bearing part 200 can be designed as an integrated load-bearing body. Specifically, secondary connecting ends 230 are provided at both ends of the load-bearing part 200, and the secondary connecting ends 230 are provided with connecting holes 231. By setting corresponding holes in the seat 20 (not shown), a reliable connection between the load-bearing part 200 and the seat 20 is achieved. The connection method can be set as screw connection, rivet connection, pin connection, or any other connection method to achieve fixed or rotational connection. This solution is particularly suitable for application scenarios that require reducing overall weight.

In this embodiment, when the load-bearing rod 10 for a seat provides support force, the load-bearing wall 210 formed on the load-bearing part 200 is used for force support. According to the structure of the load-bearing part 200, sufficient support strength is provided, ensuring that the entire load-bearing rod for a seat can maintain a stable shape during long-term use without bending or deforming due to external forces.

Specifically, referring to FIG. 5, the inner wall surface 220 of the load-bearing part 200 encloses to form an accommodating chamber 221. The accommodating chamber 221 is used to accommodate and position the rod 100, so that the outer surface 103 of the rod 100 and the inner wall surface 220 of the load-bearing part 200 form a contact fit through welding. Preferably, a polymer damping layer is added between the contact surfaces to effectively suppress structural resonance.

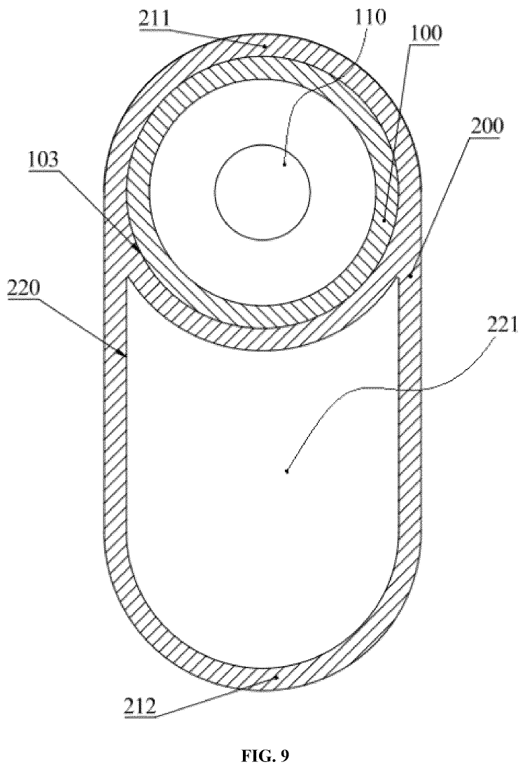

In another embodiment, referring to FIG. 9, the accommodating chamber 221 of the load-bearing part 200 is integrally formed with an annular enclosing wall. The enclosing wall has an inner diameter that matches the outer diameter of the rod 100, forming a clearance fit, allowing the load-bearing part 200 to rotate and position around the rod 100. The enclosing wall extends continuously in the circumferential direction to form a closed-loop structure, achieving radial positioning and axial limitation of the rod 100 through precisely machined mating surfaces.

In other embodiments (not shown), the attaching end 211 of the load-bearing part 200 and the outer surface 103 of the rod 100 are not limited to welded fixed connections. They can also be set as integrally formed, screw connections, rivet connections, and any other connection methods that meet the requirements.

In the preferred embodiment of the present disclosure, the seat 20 includes seat frames 23 on both sides and a load-bearing fabric (not shown) sleeved on the load-bearing rod 10 for a seat. The load-bearing rod 10 for a seat uses the distal end 212 of the load-bearing wall 210 as the main contact surface with the load-bearing fabric.

In practical applications of the preferred embodiment of the present disclosure, the operation method is as follows: when the user sits on the load-bearing fabric, the load-bearing rod 10 for a seat begins to provide support; at this time, it can rotate relative to the seat frames 23 on both sides, rotating the distal end 212 of the load-bearing wall 210 to the most suitable main force-bearing angle.

In summary, the present disclosure achieves outstanding technical effects through its unique design. The load-bearing part 200 and the rod 100 form a sleeve-type structure, ensuring that the load-bearing rod 10 for a seat maintains a stable shape during long-term use and does not bend or deform due to external forces. At the same time, when under pressure, the load-bearing part 200 can automatically rotate and adjust to form the optimal force-bearing angle, significantly enhancing the load-bearing capacity of the load-bearing rod 10 for a seat, making it suitable for various scenarios that require supporting heavy objects.

The technical solution of the present disclosure has a wide range of application scenarios, including but not limited to the following: in daily life, it can be used for furniture such as office chairs, dining chairs, and car seats that need to support human weight; in the industrial field, it can also provide reliable support for the seating parts of industrial equipment, machinery, and other structures. Through the innovative design of the core structure, the present disclosure achieves a significant breakthrough in load-bearing performance and service life while controlling costs.

The technical means disclosed in the scheme of the present invention are not limited to the technical means disclosed in the above embodiments, but also include the technical scheme composed of any combination of the above technical features. It should be pointed out that for those skilled in the art, several improvements and embellishments can be made without departing from the principle of the present invention, and these improvements and embellishments are also regarded as the protection scope of the present invention.

The invention has now been described in detail for the purposes of clarity and understanding. However, those skilled in the art will appreciate that certain changes and modifications may be practiced within the scope of the appended claims.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements, and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example.

The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Similarly, the use of “based at least in part on” is meant to be open and inclusive, in that a process, step, calculation, or other action “based at least in part on” one or more recited conditions or values may, in practice, be based on additional conditions or values beyond those recited. Headings, lists, and numbering included herein are for ease of explanation only and are not meant to be limiting.

The various features and processes described above may be used independently of one another, or may be combined in various ways. All possible combinations and sub-combinations are intended to fall within the scope of the present disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed examples. Similarly, the example systems and components described herein may be configured differently than described. For example, elements may be added to, removed from, or rearranged compared to the disclosed examples.

What is claimed is:

1. A load-bearing rod for a seat, comprising:
a rod, extending axially, with both ends respectively provided with a first connecting end and a second connecting end for assembly and connection with the seat; and
a load-bearing part, located between the first connecting end and the second connecting end of the rod, the load-bearing part comprising a load-bearing wall extending radially outward from the rod, the load-bearing wall having an attaching end and a distal end opposite to each other, the attaching end being configured for connection with the rod, and the distal end extending from the rod constituting a stress surface for bearing external loads.

2. The load-bearing rod for a seat according to claim 1, wherein the rod has a hollow tubular structure and both ends are provided with openings.

3. The load-bearing rod for a seat according to claim 2, wherein a cross-sectional shape of the rod is selected from one of a circle, polygon, or ellipse.

4. The load-bearing rod for a seat according to claim 1, wherein the load-bearing part is extended to form an accommodating chamber having an inner wall surface, and the accommodating chamber can accommodate at least part of the rod;
wherein the rod is placed in the accommodating chamber, and an outer surface of the rod is in contact with the inner wall surface.

5. The load-bearing rod for a seat according to claim 4, wherein a sleeve structure is provided in the load-bearing part and is sleeved on the rod, wherein the sleeve structure comprises an attaching part engaging with the outer surface of the rod to form the attaching end, the attaching part is shaped to allow relative rotation with the rod, and the load-bearing part is able to rotate around the rod to dynamically adjust a stress distribution area.

6. The load-bearing rod for a seat according to claim 4, wherein a buffer layer is provided between the inner wall surface of the load-bearing part and the outer surface of the rod.

7. The load-bearing rod for a seat according to claim 1, wherein anti-slip patterns or protrusions are provided on the distal end of the load-bearing wall.

8. The load-bearing rod for a seat according to claim 1, wherein a ratio of an axial length of the load-bearing part to an axial length of the rod is 1:1.1 to 1:1.3.

9. The load-bearing rod for a seat according to claim 1, wherein the load-bearing part has a racetrack-shaped cross-section.

10. The load-bearing rod for a seat according to claim 2, wherein both the first and second connecting ends are provided with fixing holes.

11. A load-bearing rod for a seat, comprising:
a rod, which is hollow and slender, extending axially, having first and second connecting ends for mounting to a seat frame structure; and
a load-bearing part, arranged around the rod and located between the first and second connecting ends of the rod; wherein
the load-bearing part comprises a load-bearing wall extending radially outward from the rod, and the load-bearing wall has a proximal end and a distal end relative to the rod;
wherein, the proximal end is configured as an attaching end for connecting to the rod, and the distal end is configured with a load-bearing surface forbearing external loads.

12. The load-bearing rod for a seat according to claim 11, wherein a cross-sectional shape of the rod is selected from one of a circle, polygon, or ellipse.

13. The load-bearing rod for a seat according to claim 11, wherein both the first and second connecting ends are provided with fixing holes.

14. The load-bearing rod for a seat according to claim 11, wherein the load-bearing part is extended to form an accommodating chamber having an inner wall surface, and the accommodating chamber is capable of accommodating at least part of the rod;
Wherein the rod is placed in the accommodating chamber, and an outer surface of the rod is in contact with the inner wall surface.

15. The load-bearing rod for a seat according to claim 14, wherein a sleeve structure is arranged in the load-bearing part and sleeved on the rod, wherein the sleeve structure comprises an attaching part engaging the outer surface of the rod to form the attaching end, the attaching part is shaped to allow relative rotation with the rod, and the load-bearing part is able to rotate around the rod to dynamically adjust a stress distribution area.

16. The load-bearing rod for a seat according to claim 14, wherein a buffer layer is provided between the inner wall surface of the load-bearing part and the outer surface of the rod.

17. The load-bearing rod for a seat according to claim 14, wherein the load-bearing part has a racetrack-shaped cross-section.

18. The load-bearing rod for a seat according to claim 11, wherein anti-slip patterns or protrusions are provided on the distal end of the load-bearing wall.

19. The load-bearing rod for a seat according to claim 11, wherein a ratio of an axial length of the load-bearing part to an axial length of the rod is 1:1.1 to 1:1.3.

20. The load-bearing rod for a seat according to claim 11, wherein a wall thickness of the load-bearing part gradually changes along an extending direction of the rod to adapt to stress distribution requirements under different loads.
